(19) United States
(12) Patent Application Publication
(10) Pub. No.: US 2026/0331085 A1
(43) Pub. Date: Oct. 22, 2026

(54) DEVICES AND METHODS FOR ADVANCED MUSICAL INSTRUMENT SYSTEMS

(71) Applicant: Jacob Scott Sinclair, Los Angeles, CA (US)

(72) Inventor: Jacob Scott Sinclair, Los Angeles, CA (US)

(21) Appl. No.: 19/105,646

(22) PCT Filed: Aug. 24, 2023
(86) PCT No.: PCT/US2023/072869

§ 371 Date: Feb. 21, 2025

Related U.S. Application Data
(60) Provisional application No. 63/401,098, filed on Aug. 25, 2022.

(51) Int. Cl. G10H 1/34; G10H 1/00

(52) U.S. Cl. CPC G10H 1/342; G10H 1/0008; G10H 2220/096; G10H 2220/301; G10H 2230/051; G10H 2230/145; G10H 2240/311

(57) ABSTRACT

Disclosed herein is a musical device comprising: (i) a neck portion, wherein the neck portion comprises a first electronic musical instrument, and wherein the neck portion is configured to receive the first electronic musical instrument and conceal a portion of the first electronic musical instrument; (ii) a body portion, wherein the body portion is connected to the neck portion, and wherein the body portion comprises a second electronic musical instrument, and wherein the body portion is configured to receive the second electronic musical instrument and conceal a portion of the second electronic musical instrument; and (iii) a controller mechanism, wherein the controller mechanism is disposed in the neck portion and/or the body portion and connected to at least one of the first electronic musical instrument and the second electronic musical instrument, and configured to control at least one parameter of the first electronic musical instrument and the second electronic musical instrument.

### RELATED APPLICATIONS

This patent application claims the benefit of U.S. Provisional Patent Application No. 63/401,098, which is hereby incorporated by reference in its entirety.

### FIELD

The disclosure relates to a musical instrument device for positioning a musician in relation to one or more electronic musical instruments disposed within a traditional stringed musical instrument (e.g., electric guitar, acoustic guitar, bass guitar, etc.).

### BACKGROUND

Learning to play a musical instrument is a time-intensive endeavor. Thus, most musicians learn to play a particular musical instrument (e.g., guitar) and not focus on learning other musical instruments (e.g., piano). Those musicians that do learn to play multiple musical instruments have to learn to position their hands, forearms, and other anatomical features in relation to the instrument (e.g., a musician's positioning playing a guitar versus a piano). This difference of positioning may lead to a number of issues for a musician that is more comfortable playing one instrument versus another.

Depending on the environment, it may also be difficult for a musician to bring more than one type of instrument to a particular event (e.g., a musical gig, a recording session, etc.). For example, if a musician is primarily a guitar player, but would like to play piano during a live concert, the musician is faced with a number of logistical issues, including carrying a separate piano and associated amplifiers, controllers, seats, stands, and other hardware, which also leads to a number of other issues for the sound system (requiring additional mixing channels and oversight from a sound engineer) and/or when the musician actually plays the guitar versus the piano and has to switch between different positions, instruments, mixes, etc.—among other such issues.

Accordingly, the present disclosure relates to portable, self-contained, musical devices and systems for allowing a musician to play and control one or more electronic musical instruments in a convenient, effective manner.

### SUMMARY

In one aspect, a musical device is provided. The musical device includes: (i) a neck portion, wherein the neck portion comprises a first electronic musical instrument, and wherein the neck portion is configured to receive the first electronic musical instrument and conceal one or more portions of the first electronic musical instrument; (ii) a body portion, wherein the body portion is connected to the neck portion, and wherein the body portion comprises a second electronic musical instrument, and wherein the body portion is configured to receive the second electronic musical instrument and conceal one or more portions of the second electronic musical instrument; and (iii) a controller mechanism, wherein the controller mechanism is disposed in at least one of the neck portion and the body portion, and wherein the controller mechanism is connected to at least one of the first electronic musical instrument and the second electronic musical instrument, and wherein the controller mechanism is configured to control at least one parameter of the first electronic musical instrument and the second electronic musical instrument.

In another aspect, an example method for manufacturing a musical device is provided. The method includes: (i) modifying a neck portion of a guitar to include a first electronic musical instrument, wherein the neck portion is modified to receive the first electronic musical instrument and conceal one or more portions of the first electronic musical instrument; (ii) modifying a body portion of the guitar to include a second electronic musical instrument, wherein the body portion is modified to receive the second electronic musical instrument and conceal one or more portions of the second electronic musical instrument; and (iii) implementing a controller mechanism in the guitar, wherein the controller mechanism is disposed in at least one of the neck portion and the body portion, and wherein controller mechanism is connected to at least one of the first electronic musical instrument and the second electronic musical instrument, and wherein the controller mechanism is configured to control at least one parameter of the first electronic musical instrument and the second electronic musical instrument.

### BRIEF DESCRIPTION OF THE FIGURES

FIG. 1 depicts an example computing device, in accordance with example embodiments.

FIG. 2A depicts an example musical device and architecture, in accordance with example embodiments.

FIG. 2B depicts the example musical device and architecture of FIG. 2A, from a second perspective.

FIG. 3 depicts an example musical device and architecture, in accordance with example embodiments.

FIG. 4 depicts an example musical device and architecture, in accordance with example embodiments.

FIG. 5 depicts an example method, in accordance with example embodiments.

### DETAILED DESCRIPTION

The disclosure is directed to portable, self-contained, musical devices and systems for allowing a musician to play and control one or more musical instruments in a convenient, effective manner to improve a musician's experience with and ability to play one or more musical instruments disposed within a traditional stringed musical instrument (e.g., electric guitar, acoustic guitar, bass guitar, etc.). These improvements will benefit novice musicians and those that have been playing for many years, alike.

In one aspect, a musical device is disclosed that allows a musician to play two electronic musical instruments in the form similar to an electric guitar via new systems and extensive modifications to a number of guitar components and guides a musician's hands and forearms to play the two electronic musical instruments where the musician's hands and forearms would otherwise be picking and/or strumming a guitar.

By doing so, the disclosed musical device encourages the musician to utilize the control and positioning of playing a guitar, including in their fretting and picking/strumming hands, instead of belaboring new methods of positioning and playing instruments other than guitar (e.g., seated, playing a piano). As detailed further below, the disclosed musical device provides an improved experience for the musician through, among other things, specifically shaped body and neck portions of the musical instrument, as well as one or more particular configurations of electronic musical instruments and associated controller mechanisms disposed in the body and neck portions. As used herein, the terms “user” and “musician” are used interchangeably, and refer to, among other things, the user/musician of the claimed musical instruments, as detailed further herein.

Further, although the illustrations included in this application primarily illustrate the device in the context of a semi-hollow-body electric guitar, the claimed musical device can easily be adapted for any number of body shapes and styles of guitars. These guitars include electric guitars (e.g., solid-body electric guitars, hollow-body electric guitars) made by a number of well-known electric guitar manufacturers (e.g., Fender®, Gibson®), over a number of specific model numbers (e.g., Fender® Stratocaster®, Fender® Telecaster®, Gibson® Les Paul®, Fender® Starcaster®, Gibson® ES-335). These guitars may also include acoustic guitars (e.g., jumbo acoustic guitars, smaller body acoustic guitars, classical acoustic guitars, parlor guitars) made by a number of well-known acoustic guitar manufacturers (e.g., C.F. Martin®, Gibson®, Taylor®), over a number of specific model numbers (e.g., C.F. Martin® D-28, C.F. Martin® OM-28, C.F. Martin® D-28-12, Gibson® J-45, Gibson® J-200, Taylor® 314).

Additionally, the claimed musical devices and methods can also be adapted for any number of other types, styles, and shapes of other types of guitars (e.g., electric bass guitars) made by a number of well-known manufacturers (e.g., Fender®, Gibson®), over a number of specific model numbers (e.g., Fender® Jazz Bass®, Fender® Precision Bass®). To do so, the disclosed musical device may be made up of one or more different configurations depending on the specific body and neck portions of the musical instrument, as well as one or more particular configurations of electronic musical instruments and associated controller mechanisms disposed in the body and neck portions.

In one aspect, the disclosure is directed to a musical device containing two electronic musical instruments disposed in the body and neck portions of a semi-hollow-body electric guitar, which further includes one or more controller mechanisms connected to at least one of the two electronic musical instruments.

In one aspect, the musical device includes a neck portion. In example embodiments, the neck portion includes a first electronic musical instrument. In examples embodiments, this first electronic musical instrument includes one or more of the following: (i) a musical instrument digital interface (MIDI) instrument; (ii) a monophonic synthesizer instrument; (iii) a polyphonic synthesizer instrument; (iv) an electronic keyboard instrument; (v) a theramin instrument; (vi) a touchpad controller instrument; and (vii) a sampler instrument, among other possibilities.

In some example embodiments, the neck portion is configured to receive the first electronic musical instrument in a specific manner. For example, the neck portion may be configured to receive the first electronic musical instrument at an angle or orientation that is most consistent with how a musician would typically play the neck portion of the musical device. For example, if the musical device is a guitar, the neck portion may be configured to receive the first electronic musical instrument so that the one or more pads or keys of the first electronic musical instrument are oriented and level with the fretboard of the guitar. Other examples are possible.

In a further aspect, the neck portion may be configured to receive the first electronic musical instrument so that one or more portions of the first electronic musical instrument are concealed in and by the neck portion. For example, in some embodiments, one or more routed channels in the neck portion may conceal one or more portions of the first electronic musical instrument (e.g., wires, circuit boards, etc.) so that the musician's ability to play the first electronic musical instrument is improved (e.g., by concealing all of the wires associated with the first electronic musical instrument), as are other aesthetic and functional aspects of the musical device.

In a further aspect, the neck portion may be configured to receive the first electronic musical instrument so that the portions of the first musical instrument that are used to play the first musical instrument (e.g., one or more pads, keys, buttons, etc.) are spaced and/or oriented in a manner that consistent with a typical guitar or bass neck. In this respect, a musician may feel as though they are playing the first electronic musical instrument in a manner that is consistent with playing a typical guitar or bass neck. In alternative embodiments, one or more additional features may be added to the neck portion to improve the musician's perception and experience of playing the first musical instrument in a manner that he/she/they would typically play a guitar or bass neck. For example, in some examples, the neck portion may be configured to have one or more portions on the received first electronic musical instrument that have features that are typical to guitar or bass necks, including one or more frets (e.g., on the portion that receives the first electronic musical instrument, on the portion surrounding the first electronic musical instrument, or both). In a further aspect, the first electronic musical instrument may be configured to have a surface radius that matches the surface radius of a specific guitar or bass neck and/or a specific guitar or bass manufacturer (e.g., Gibson®, Fender®)

In a further aspect, the neck portion and/or the received first electronic musical instrument may contain one or more portions and/or components that have features that are typical to guitar or bass necks, including that one or more pads, keys, buttons, etc., of the first electronic musical instrument are made of one or more materials that are commonly used in guitar or bass necks (e.g., maple, rosewood, ebony, etc.). In a further aspect, although not specifically illustrated herein, the first electronic musical instrument may be received in the neck portion such that the first electronic musical instrument is disposed under a guitar or bass fretboard and/or otherwise integrated into a guitar or bass fretboard. Other examples are possible.

In a further aspect, the musical device includes a body portion. In example embodiments, the body portion includes a second electronic musical instrument. In examples embodiments, this second electronic musical instrument includes one or more of the following: (i) a musical instrument digital interface (MIDI) instrument; (ii) a monophonic synthesizer instrument; (iii) a polyphonic synthesizer instrument; (iv) an electronic keyboard instrument; (v) a theramin instrument; (vi) a touchpad controller instrument; and (vii) a sampler instrument, among other possibilities.

In some example embodiments, the body portion is configured to receive the second electronic musical instrument in a specific manner. For example, the body portion may be configured to receive the second electronic musical instrument at an angle or orientation that is most consistent with how a musician would typically play the body portion of the musical device. For example, if the musical device is a guitar, the body portion may be configured to receive the second electronic musical instrument so that the one or more pads or keys of the second electronic musical instrument are oriented toward the musician while the musical device is worn in a manner consistent with playing and/or wearing a guitar (e.g., via a shoulder strap). In a further aspect, the second electronic musical instrument may be angled and level with the typical spot that a musician would otherwise strum and/or pick the strings of a guitar (e.g., approximately in the center of the top surface of the body portion of the guitar, in front of the bridge of the guitar). Other examples are possible.

In a further aspect, the body portion may be configured to receive the second electronic musical instrument so that one or more portions of the second electronic musical instrument are concealed in and by the body portion. For example, in some embodiments, one or more routed channels in the body portion may conceal one or more portions of the second electronic musical instrument (e.g., wires, circuit boards, etc.) so that the musician's ability to play the second electronic musical instrument is improved (e.g., by concealing all of the wires associated with the second electronic musical instrument), as are other aesthetic and functional aspects of the musical device.

In a further aspect, the body portion may be configured to receive the second electronic musical instrument so that the portions of the second musical instrument that are used to play the first musical instrument are spaced and/or oriented in a manner that consistent with a typical guitar or bass body. In this respect, a musician may feel as though they are playing the second electronic musical instrument in a manner that is consistent with playing a typical guitar or bass. In alternative embodiments, one or more additional features may be added to the body portion to improve the musician's perception and experience of playing the second musical instrument in a manner that he/she/they would typically play a guitar or bass. For example, in some examples, the body portion may be configured to have one or more portions on the received second electronic musical instrument that have features that are typical to guitar or bass body, including a vibrato tailpiece (often referred to as a “whammy bar”) that is connected to and/or enable the first electronic musical instrument, second electronic musical instrument, or both to produce a vibrato effect (or other types of effects, including volume and/or pitch) when the first electronic musical instrument, second electronic musical instrument, or both are played and the vibrato tailpiece in engaged by the musician.

In a further aspect, the body portion and/or the received second electronic musical instrument may contain one or more portions and/or components that have features that are typical to guitar or bass bodies, including that one or more pads, keys, buttons, etc., of the second electronic musical instrument are made of one or more materials that are commonly used in guitar or bass bodies (e.g., maple, rosewood, ebony, etc.). In a further aspect, although not specifically illustrated herein, the second electronic musical instrument may be received in the body portion such that the second electronic musical instrument is disposed under one or more surfaces of the guitar or bass body (e.g., the top surface of the guitar or bass body portion) and/or otherwise integrated into a guitar or bass body portion. Other examples are possible.

In a further aspect, in example embodiments, the body portion is connected to the neck portion, and the body portion and the neck portion may be connected in a number of ways. For example, the body portion and the neck portion may be connected by one or more screws (e.g., four screws and an associated screw plate), which is often referred to as a “bolt-on configuration”. In other examples, the body portion and the neck portion may be connected by one or more physical joints in the body portion, the neck portion, or both, as well as various adhesives (e.g., (i) a mortise and tenon joint; (ii) a dovetail joint; (iii) wood glue adhesive; and/or (iv) hide glue adhesive)).

In a further aspect, the musical device includes a controller mechanism. In example embodiments, the controller mechanism is disposed in at least one of the neck portion and the body portion and connected to at least one electronic musical instrument and provides a musician control over one or more parameters of the at least one electronic musical instrument. In examples embodiments, these parameters of the at least one electronic instrument include one or more of the following: (i) volume; (ii) tone; (iii) pitch; (iv) modulation; (v) velocity control; (vi) oscillation; (vii) filter; (viii) release; (ix) attack; (x) sustain; and (xi) stored sound patches of the at least one electronic musical instrument, among other possibilities. In a further aspect, the controller mechanism may be configured to control an output parameter of one or more electronic musical instruments or features thereof. For example, the controller mechanism may be configured to blend between the outputs of different virtual musical instruments (i.e., stored sound patches) of a first electronic musical instrument (e.g., blend between the relative outputs of a first sound patch corresponding to a first virtual musical instrument and a second sound patch corresponding to a second virtual musical instrument). In other examples, the controller mechanism may be configured to blend between the outputs of different electronic musical instruments (e.g., blend between the relative outputs of first electronic musical instrument and a second electronic musical instrument).

In some example embodiments, the neck portion and/or the body portion are configured to receive the controller mechanism in a specific manner and the controller mechanism may be specifically implanted into the neck portion and/or the body portion accordingly. For example, the body portion may be configured to receive the controller mechanism pursuant to controller layout or at an angle or orientation that is most consistent with how a musician would typically interact with controllers (e.g., one or more potentiometers and/or switches) on the body portion of a musical device. For example, if the musical device is a guitar, the body portion may be configured to receive the controller mechanism so that one or more potentiometers, switches, graphical user interfaces, etc., associated with at least one electronic musical instrument are laid out in a manner that is consistent with typical controllers on the body portion of a guitar and oriented toward the musician while the musical device is worn in a manner consistent with playing and/or wearing a guitar (e.g., via a shoulder strap). In a further aspect, the controller mechanism may be angled and level with the typical spot that a musician would otherwise interact with the controllers of a guitar (e.g., approximately in the outside parameter of the top surface of the body portion of the guitar, below the bridge of the guitar and/or on an upper portion of the top surface of the body portion of the guitar, near a location of one or more strap buttons on the guitar). Other examples are possible.

In a further aspect, the neck portion and/or the body portion may be configured to receive the controller mechanism so that one or more portions of the controller mechanism are concealed in and by the neck portion and/or the body portion. For example, in some embodiments, one or more routed channels in the neck portion and/or body portion may conceal one or more portions of the controller mechanism (e.g., wires, potentiometers, switches, etc.) so that the musician's ability to control at least one electronic musical instrument is improved (e.g., by concealing all of the wires associated with the electronic musical instrument and presenting the controller mechanism in a layout that is intuitive and convenient for the musician), as are other aesthetic and functional aspects of the musical device.

In a further aspect, the musical device includes a battery. In example embodiments, the battery is disposed in at least one of the neck portion and the body portion and connected to at least one electronic musical instrument and provides power to the at least one electronic musical instrument. In example embodiments, the battery may be rechargeable and also include a visual indicator disposed in one or more portions of the musical device (e.g., on the top of the body portion of a guitar) that indicates the amount of charge or power remaining in the battery at given moment in time. In example embodiments, the battery may include one or more power switches that provide an on/off switch for the first electronic musical instrument and/or the second electronic musical instrument, among other possibilities.

In a further aspect, the neck portion and/or the body portion may be configured to receive the battery so that one or more portions of the battery are concealed in and by the neck portion and/or the body portion. For example, in some embodiments, one or more routed channels in the neck portion and/or body portion may conceal one or more portions of the battery (e.g., wires, switches, etc.) so that the musician's ability to control the power provided to the at least one electronic musical instrument is improved (e.g., by concealing all of the wires associated with the electronic musical instrument and presenting the battery control in a layout that is intuitive and convenient for the musician), as are other aesthetic and functional aspects of the musical device.

### I. Computing Device

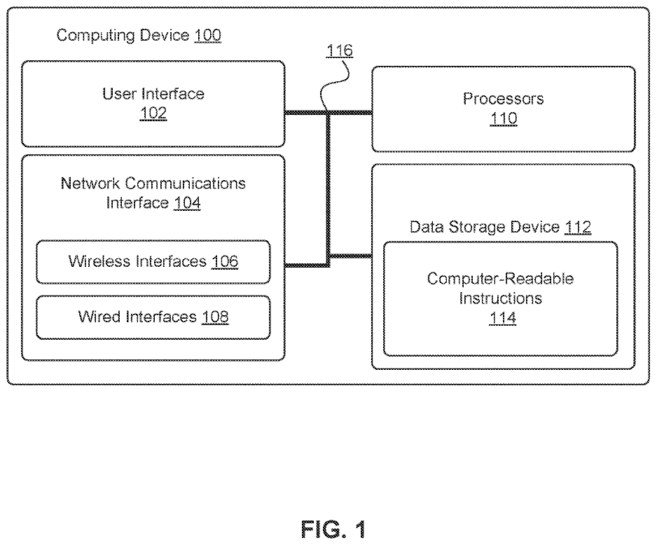

FIG. 1 illustrates computing device 100 in accordance with example embodiments, which may be configured to perform at least the functions of the controller mechanism and/or various aspects of the electronic musical instrument, as previously described.

Computing device 100 includes one or more user interfaces 102, a network-communication interface 104 (comprising one or more wireless interfaces 106 and/or wired interfaces 108), one or more processors 110, and a data storage device 112 with computer-readable program instructions 114 stored thereon, all of which may be linked together by a connector 116, such as electrically conductive wires or similar mechanisms.

In operation, the user interface 102 (described above in connection with, at least controller mechanism) may be configured to receive and/or convey information and/or data to/from a user (e.g., musician) using the musical device and/or electronic musical instruments described herein. In one example, the user interface 102 is a touch screen that displays one or more graphical user interfaces to receive and convey information from and to the user. In other examples, the user interface 102 receives information and/or data from a user through the use of one or more components of the controller mechanism (e.g., potentiometers, switches, etc.), one or more components of an electronic musical instruments (e.g., of an electronic keyboard), one or more cameras, and/or one or more microphones (which may also work in connection with voice recognition software), among other such devices. In other examples, the user interface 102 is configured to convey information and/or data to a user through the use of display devices (which may include LCD, LED, and/or plasma, among other, screens, and/or other similar devices, either now known or later developed) and/or speakers (or an audio output port configured to send an audio signal to an external device), among other similar devices.

Computing device 100 may also include one or more network-communications interfaces 104, which may comprise one or more wireless interfaces 106 and/or one or more wired interfaces 108, both or either of which may be configured to communicate via a network. For example, wireless interfaces 106 may include wireless receivers, wireless transmitters, and/or wireless transceivers, one or more of which may employee technologies such as Bluetooth, WIFI, wireless receivers, wireless transmitters, and/or wireless transceivers, and/or other similar types of similar technologies. In other examples, wired interfaces 108 may include one or more wired receivers, wired transmitters, and/or wired transceivers, one or more of which may employee technologies such as MIDI cables, instrument cables, coaxial, Ethernet, USB, and/or other similar types of similar technologies.

Computing device 100 also includes one or more processors 110, which are configured to execute computer-readable program instructions 114 that are contained in data storage devices 112 and/or other instructions as described herein. In operation, the one or more processors 110 are configured to execute the software for playing, controlling, and/or interacting with one or more components of musical device (e.g., the controller mechanism and/or at least one electronic musical instrument disposed in the musical device, as described in further detail herein).

Computing device 100 also includes one or more data storage devices 112, one or more of which may include one or more computer-readable storage media that can be read and/or accessed by the at least one or more processors 110. In a further aspect, one or more data storage devices 112 can also contain, among other data, computer-readable program instructions 114. And, in some embodiments, data storage device 112 can additionally include instructions required to perform at least part of the functionality (including the musical device functionality, methods, and method steps described herein). Other examples are possible.

### II. Musical Instrument Device and Architecture

In the following sections, references will be made, in some detail, to various embodiments of the systems and methods disclosed herein. Although the following detailed descriptions provide many details to provide a context to ensure a full understanding of the present disclosure for the reader, these descriptions should not be viewed as limitations. Further, the disclosed systems and methods may be accomplished without all of these specific details.

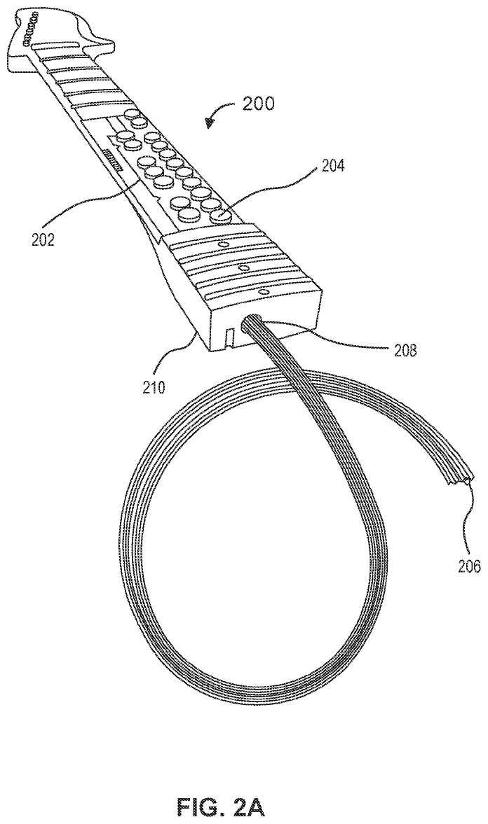

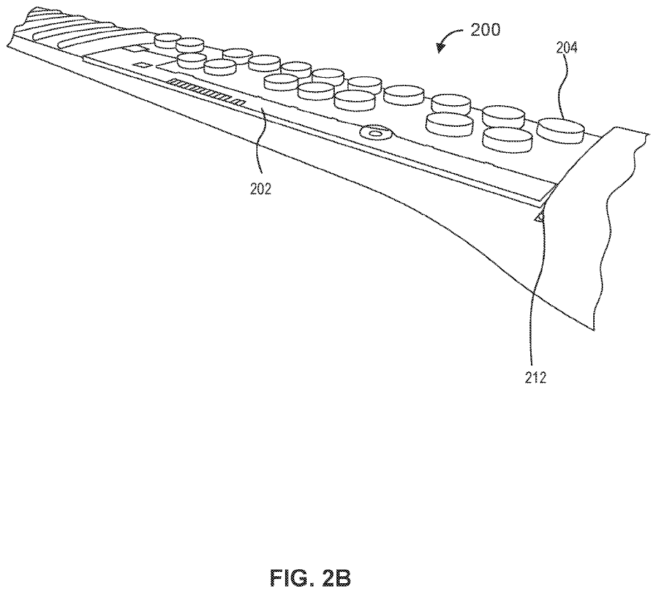

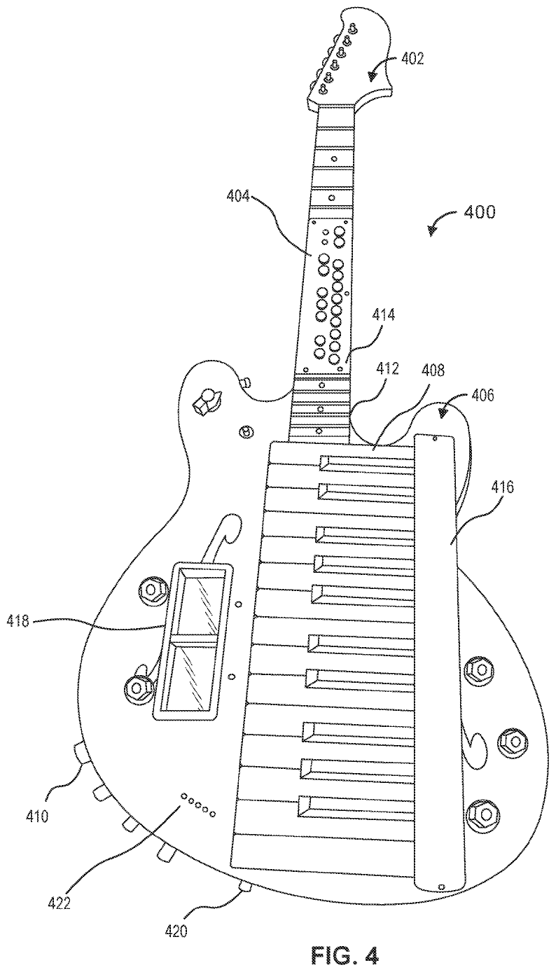

FIG. 2A shows a first perspective view of a neck portion 200 (a guitar neck) of an example musical device (a guitar), in accordance with example embodiments. More specifically, neck portion 200 includes, at least, an electronic musical instrument 202 (a synthesizer) with one or more pads 204 and associated wires 206 disposed in a routed channel 208, and a structural connection portion 210 (e.g., for connecting the neck portion to a body portion of a musical device). In a further aspect, in this example, electronic musical instrument 202 communicates with additional components of the musical device (e.g., a controller mechanism and/or another electronic musical instrument, potentially disposed in a body portion of a musical device, described further herein) via engaging one or more of the illustrated pads 204, which in turn sends an electronic signal via one or more wires 206 disposed in a routed channel 208. Furthermore, in the illustrated embodiment, illustrated components, including those of neck portion 200, may be encased in one or more specifically configured enclosures, including enclosures further detailed in connection with FIG. 4, described in further detail herein.

FIG. 2B shows a second perspective view of the neck portion 200 of FIG. 2A, in accordance with example embodiments. More specifically, FIG. 2B illustrates, among other features, a more detailed view of the electronic musical instrument 202 and associated pads 204 disposed in a recess 212 of the neck portion 200. In the illustrated embodiment, the electronic musical instrument 202 and associated pads 204 are specifically oriented in the recess 212 (which is created using extensive modifications to the neck of a guitar) and guides a musician's hands to play the plurality of pads of the electronic musical instrument where the musician's hands would fretting the guitar's strings. By doing so, this specific configuration encourages the musician to utilize the control and positioning of playing a guitar, including in their fretting and picking/strumming hands, instead of positioning and playing the electronic musical instrument in the typical manner (e.g., seated). Other examples are possible.

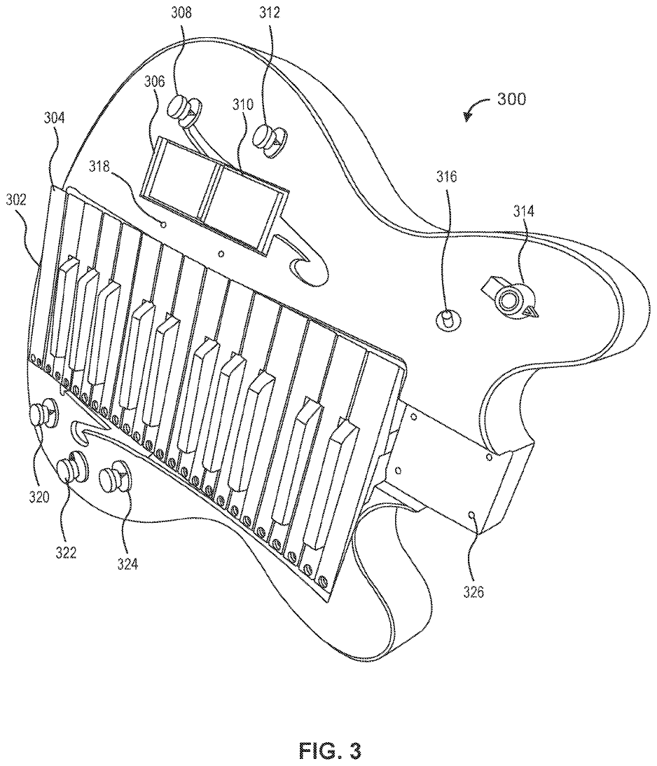

For example, FIG. 3 shows a body portion 300 (a guitar body) of an example musical device (a guitar), in accordance with example embodiments. More specifically, body portion 300 includes, at least, an electronic musical instrument 302 (an electronic keyboard) with one or more keys 304 and an associated controller mechanism that includes a first graphical user interface 306 and first graphical user interface controller 308, a second graphical user interface 310 and second graphical user interface controller 312, blending controller 314, selector switch 316, one or more visual indicators 318, a first parameter controller 320, a second parameter controller 322, a third parameter controller 324, and a structural connection portion 326 (e.g., for connecting the body portion to a neck portion of a musical device via, as illustrated, four screw holes in the structural connection portion 326). Furthermore, although not specifically illustrated, in FIG. 3, one or more wires are disposed within the semi-hollow-body portion and/or one or more specifically routed channels).

In a further aspect, in this example, electronic musical instrument 302 communicates with additional components of the musical device, for example, the illustrated controller mechanism, another electronic musical instrument of the musical device (e.g., potentially disposed in a neck portion of the musical device, described further herein). To do so, in example embodiments, these communications occur via engaging one or more of the illustrated keys of the electronic musical instrument, the illustrated controlling mechanisms, or both, which in turn send an electronic signal via one or more wires disposed within the illustrated body portion 300. Furthermore, in the illustrated embodiment, illustrated components, including those of body portion 300, may be encased in one or more specifically configured enclosures, including enclosures further detailed in connection with FIG. 4, described in further detail herein.

As shown in FIG. 3, electronic musical instrument 302 may be controlled and/or interacted with in one or more ways. For example, the illustrated controller mechanism includes a first graphical user interface 306 and first graphical user interface controller 308, and a second graphical user interface 310 and second graphical user interface controller 312. These graphical user interfaces may display a range of information to the musician and also allow the musician to interact with and operate one or more electronic musical instruments of the musical device. For example, the first and second graphical user interfaces may be configured to each display one of two different virtual musical instruments and/or stored sound patches of electronic musical instrument 302. For example, electronic musical instrument 302 may be able to utilize two different virtual musical instruments and/or stored sound patches at the same time (e.g., a piano sound patch and an organ sound patch), both of which may be played using one or more keys 304. In this regard, in example embodiments, each of the first graphical user interface 306 and second graphical user interface 310 may display a different virtual musical instrument and/or stored sound patch, as well as information pertaining to the user's control and/or selection of each of the different virtual musical instruments and/or stored sound patches via first graphical user interface controller 308 and second graphical user interface controller 312. In one example, first graphical user interface controller 308 allows the musician to scroll through and select the first virtual musical instrument and/or stored sound patch (displayed via first graphical user interface 306) and second graphical user interface controller 312 allows the musician to scroll through and select the second virtual musical instrument and/or stored sound patch (displayed via second graphical user interface 310). Other examples are possible.

In some embodiments, first graphical user interface controller 308 and/or second graphical user interface controller 312 may be configured to allow the musician to take more than one action in connection with the associated virtual musical instrument, stored sound patch, and/or graphical user interface 306. For example, in some embodiments, the graphical user interface controller may allow the musician to scroll through one or more virtual musical instruments/sound patches displayed on an associated graphical user interface by turning the controller in a clockwise/counterclockwise fashion and then allow the user to select a particular virtual musical instrument/sound patch by pressing down on the top of the controller. In a further aspect, this type of dual-action configuration for the controller may also allow the user to select and/or edit one or more parameters of a particular virtual musical instrument/sound patch by pressing down on the top of the controller to select a particular parameter and then edit that parameter (e.g., increase or decrease that parameter) by turning the controller in a clockwise/counterclockwise fashion. Other examples are possible.

For example, in example embodiments, the illustrated controller mechanism also includes blending controller 314 and selector switch 316. In example embodiments, the blending controller 314 may be configured to blend between the respective outputs of different virtual musical instruments/sound patches of electronic musical instrument 302. For example, by turning the blending controller 314 in a clockwise/counterclockwise fashion, the musician may be able to blend between the relative outputs of two different virtual musical instruments and/or stored sound patches at the same time. For example, if a first sound patch is a piano and the second sound patch is an organ: (i) the output of the piano sound patch may be 100% and the output of the organ sound patch may be 0% when the blending controller 314 is turned fully clockwise; (ii) the output of the organ sound patch may be 100% and the output of the piano sound patch may be 0% when the blending controller 314 is turned fully counterclockwise; and (iii) the output of the organ sound patch may be 100% and the output of the piano sound patch may be 100% when the blending controller 314 is in a position directly between the fully clockwise and the fully counterclockwise positions, and different output ratios in between these three positions, among other possibilities.

For example, selector switch 316 may be a three-position selector switch that can select between the relative outputs of two different virtual musical instruments and/or stored sound patches at the same time. For example, if a first sound patch is a piano and the second sound patch is an organ: (i) the output of the piano sound patch may be 100% and the output of the organ sound patch may be 0% when the selector switch 316 is a first position (e.g., fully downward position); (ii) the output of the organ sound patch may be 100% and the output of the piano sound patch may be 0% when the selector switch 316 is a second position (e.g., fully upward position); and (iii) the output of the organ sound patch may be 100% and the output of the piano sound patch may be 100% when the selector switch 316 is a third position (e.g., in the middle position, between the fully upward position and fully downward positions), among other possibilities. For example, the controller mechanism may only engage the blending controller 314 when the selector switch is in a position that engages both of the sound patches at the same time (i.e., the middle position). Other examples are possible.

For example, the selector switch may control other parameters of the electronic musical instrument and/or sound patches thereof. For example, understanding that electronic musical instrument 302 only contains 25 keys as illustrated, selector switch 316 may be a three-position selector switch that can select between different ranges, positions, or octaves of a full size piano or keyboard, which typical contains 88 keys. For example, in some embodiments, if a piano sound patch is used, the range of the sound patch may be in: (i) the lower frequency range of the piano (i.e., the bass note range of the piano) when the selector switch 316 is a first position (e.g., fully downward position); (ii) the higher frequency range of the piano (i.e., the treble note range of the piano) when the selector switch 316 is a second position (e.g., fully upward position); and (iii) the middle frequency range of the piano (i.e., the middle note range of the piano) when the selector switch 316 is a third position (e.g., in the middle position, between the fully upward position and fully downward positions), among other possibilities.

In a further aspect, one or more visual indicators 318 (e.g., LED lights) may be included in the controller mechanism and implemented in the body portion to indicate which one (of both) of the virtual musical instruments and/or stored sound patches (e.g., displayed via first graphical user interface 306 and a second graphical user interface 310) are being engaged by blending controller 314 and/or selector switch 316 (and thus being outputted from the musical device) at any given time. Other examples are possible.

For example, in example embodiments, the illustrated controller mechanism also includes a first parameter controller 320, a second parameter controller 322, a third parameter controller 324. In example embodiments, each of these parameter controllers may be configured to control a respective parameter of different virtual musical instruments/sound patches of electronic musical instrument 302, or of electronic musical instrument 302 itself. For example, each of the parameter controllers may be configured to allow the musician to control an assigned parameter by turning each of the parameter controllers in a clockwise/counterclockwise fashion, including: (i) volume; (ii) tone; (iii) pitch; (iv) modulation; (v) velocity control; (vi) oscillation; (vii) filter; (viii) release; (ix) attack; and (x) sustain, of the at least one electronic musical instrument, among other possibilities.

For example, in one embodiment, by turning each of the parameter controllers in a clockwise/counterclockwise fashion, the musician may be able to control: (i) pitch of electronic musical instrument 302 via a first parameter controller 320 (e.g., higher pitch by turning clockwise, lower pitch by turning counterclockwise); (ii) tone of electronic musical instrument 302 via a second parameter controller 322 (e.g., more trebly tone by turning clockwise, more bassy tone by turning counterclockwise); and (iii) volume of electronic musical instrument 302 via a third parameter controller 324 (e.g., more volume by turning clockwise, less volume tone by turning counterclockwise). Although this configuration has been described in connection with the pitch, tone, and volume of electronic musical instrument 302, these specific parameters should be understood as non-limiting, both in terms of functionality and control of electronic musical instrument 302, additional electronic musical instruments, and more.

For example, if the body portion 300 contains a second electronic musical instrument and/or the musical device is connected with a second electronic musical instrument (e.g., disposed in a neck portion of the guitar and connected via a controller mechanism), additional or alternative functionality of the illustrated concepts might be realized

For example, if two electronic musical instruments are connected via the controller mechanism, each of the graphical user interfaces and associated controllers of FIG. 3 may control and/or display information concerning each of the two electronic musical instruments. This example embodiment would allow the musician to interact with and operate each of the electronic musical instruments of the musical device independently. In a further aspect, in example embodiments, the illustrated blending controller 314 and/or selector switch 316 may allow the musician to blend between the respective outputs of each of a first electronic musical instrument and a second electronic musical instrument and/or select between the two instruments (or select both), using the blending controller and/or selector switch, respectively. Furthermore, in example embodiments, the illustrated parameter controllers may be configured to control a respective parameter of each of the first electronic musical instrument and second electronic musical instrument 408, or both simultaneously.

As also shown in the illustrated embodiment of FIG. 3, the electronic musical instrument 302 and associated keys 304 are specifically oriented in a recess of the body portion (which is created using extensive modifications to the body of a guitar) and guides a musician's hands to play the plurality of keys of the electronic musical instrument where the musician's hands would normally be strumming and/or picking the guitar's strings. By doing so, this specific configuration encourages the musician to utilize the control and positioning of playing a guitar, including in their fretting and picking/strumming hands, instead of positioning and playing the electronic musical instrument in the typical manner (e.g., seated). Other examples are possible.

For example, as also shown in the illustrated embodiment of FIG. 3, the components of the illustrated controller mechanism are specifically oriented in a recess of the body portion (which is created using extensive modifications to the body of a guitar) and guides a musician's hands to interact with the components of the controller mechanism in a manner that is consistent with where the musician's hands would normally be when controlling typical parameters of an electric guitar, including pickup selection, volume, tone, etc. By doing so, this specific configuration encourages the musician to utilize the control and positioning of playing a guitar, instead of positioning and controlling the electronic musical instrument in the typical manner (e.g., by turning knobs on a keyboard, seated, with a volume and/or sustain pedal, etc.). Other examples are possible.

For example, turning to FIG. 4, FIG. 4 shows a musical device 400 that includes, at least, a neck portion 402 (a guitar neck, as further detailed in connection with, at least FIGS. 2A-2B) with a first electronic musical instrument 404 (a synthesizer) with one or more pads and controlled by, at least,, a body portion 406 (a guitar body, as further detailed in connection with, at least FIG. 3) with a second electronic musical instrument 408 (an electronic keyboard) with one or more keys, and a controller mechanism disposed within the body portion that controls various parameters of the first electronic musical instrument controller mechanism 410 (disposed in body portion 406), as well as the second electronic musical instrument (as well as a litany of associated wires disposed in routed channels of neck portion 402 and body portion 406). As illustrated in FIG. 4, body portion 406 and neck portion 402 are structurally connected via one or more screws 412 (e.g., as further illustrated in FIGS. 2A-3, which include four screws and an associated screw plate) (i.e., a “bolt-on configuration”).

As further illustrated in FIG. 4, musical device 400 also includes first electronic musical instrument enclosure 414, a second electronic musical instrument enclosure 416, and a graphical user interface enclosure 418, which cover (or at least partially cover) and improve the musician's interaction with (and ability to play and utilize) various portions of musical device 400. In a further aspect, each of these enclosures may be made of one or more materials, including wood, plastic, glass, rubber, metals, metal alloys, and other such materials.

For example, first electronic musical instrument enclosure 414 may be made of the same material as the neck portion 402 (e.g., maple), and several improvements maybe realized. For example, by covering the electronic portions of first electronic musical instrument 404 (e.g., wires, circuit boards, etc.) and allowing only the pads to be exposed, the musician's experience with playing the first electronic musical instrument 404 via the pads is more consistent with the rest of the neck portion 402 and playing guitar, in general. For example, if the first electronic musical instrument enclosure 414 is configured to fill the areas of the neck portion 402 that were removed to accommodate the installation of the first electronic musical instrument 404, then the modified and unmodified portions of the neck portion may be more consistent, thereby improving the musician's experience with and ability to play the first electronic musical instrument 404. In a further aspect, first electronic musical instrument enclosure 414 also protects various components of first electronic musical instrument 404 (e.g., protects electronic components of first electronic musical instrument 404 against adverse conditions-including weather conditions and/or sweat from a musician's hands and/or forearm). Other examples are possible.

For example, like first electronic musical instrument enclosure 414, second electronic musical instrument enclosure 416 may be made of the same material as the body portion 406 (e.g., maple), and several improvements maybe realized. For example, by covering the electronic portions of second electronic musical instrument 408 (e.g., wires, actuators, circuit boards, etc.) and allowing only the keys to be exposed, the musician's experience with playing the second electronic musical instrument 408 via the keys is more consistent with playing the body portion 406 of a guitar and playing guitar, in general, thereby improving the musician's experience with and ability to play the second electronic musical instrument 408. In a further aspect, second electronic musical instrument enclosure 416 also protects various components of second electronic musical instrument 408 (e.g., protects electronic components of second electronic musical instrument 408 against adverse conditions—including weather conditions and/or sweat from a musician's hands and/or forearm). Other examples are possible.

For example, like first electronic musical instrument enclosure 414 and second electronic musical instrument enclosure 416, graphical user interface enclosure 418 may be made of the same material as the neck and/or body portions (e.g., maple), and include one or more protective filters (e.g., UV filters, polarized filters, etc.) or other components to improve the functionality of the underlying graphical user interfaces, displayed information, and the musician's interaction with the same. For example, by covering the electronic portions of the graphical user interfaces (e.g., screens, wires, circuit boards, etc.), but still allowing the content displayed on the graphical user interfaces to be visible to the musician, the musician's experience with interacting with the graphical user interfaces (including via the illustrated graphical user interface controllers) is improved and various components of the graphical user interface are protected (e.g., against adverse conditions—including glare, sunlight and other adverse weather conditions and/or sweat from a musician's hands and/or forearm). Other examples are possible.

For example, as illustrated in FIG. 4, musical device 400 may also include a battery with one or more battery controllers 420 and battery indicators 422. In example embodiments, the battery provides power to the at least one of the illustrated first electronic musical instrument 404, second electronic musical instrument 408, and/or controller mechanisms (e.g., the graphical user interfaces). In example embodiments, the battery may be rechargeable (e.g., via a port on the musical device 400) and also include battery indicators 422 disposed on the top surface of the body portion of the guitar that indicates the amount of charge or power remaining in the battery at given moment in time (e.g., on a scale of one to five illuminated LEDs indicating the level of battery charge remaining). In example embodiments, the battery may include one or more power switches that provide an on/off switch for the first electronic musical instrument, the second electronic musical instrument, and/or other components of the musical device 400, among other possibilities.

In a further aspect, the neck portion and/or the body portion of musical device 400 is configured to receive the battery so that one or more portions of the battery are concealed in and by the neck portion 402 and/or the body portion 406.

These components and example graphical user interfaces are merely for purposes of illustration. The features described herein may involve components and/or graphical user interfaces that are configured or formatted differently, including more or less information and/or additional or fewer instructions, include different types of information and/or instructions, and relate to one another in different ways.

### III. Example Method

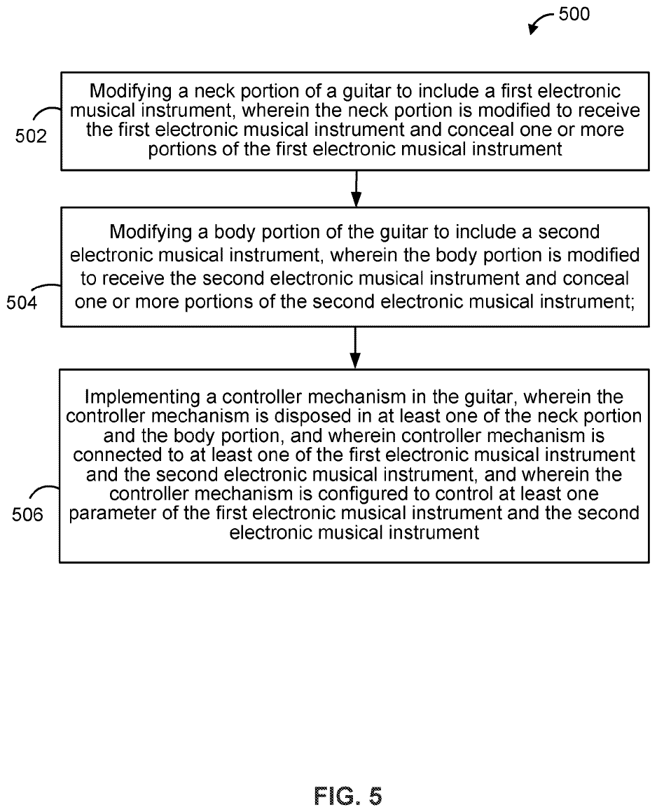

FIG. 5 is a flow chart illustrating an example method 500 for manufacturing a musical instrument. In some examples, the musical instrument is an acoustic guitar. In some examples, the musical instrument is a solid-body electric guitar. In some examples, the musical instrument is a semi-hollow-body electric guitar. In some examples, the musical instrument is a hollow-body electric guitar. In some examples, the musical instrument is a bass guitar.

At block 502, the method 500 can include, modifying a neck portion of a guitar to include a first electronic musical instrument, wherein the neck portion is modified to receive the first electronic musical instrument and conceal one or more portions of the first electronic musical instrument.

At block 504, the method 500 can include, modifying a body portion of the guitar to include a second electronic musical instrument, wherein the body portion is modified to receive the second electronic musical instrument and conceal one or more portions of the second electronic musical instrument.

In some examples, at least one of the first electronic musical instrument or the second electronic musical instrument comprises a musical instrument digital interface (MIDI) instrument. In some examples, at least one of the first electronic musical instrument or the second electronic musical instrument comprises a monophonic synthesizer instrument. In some examples, at least one of the first electronic musical instrument or the second electronic musical instrument comprises a polyphonic synthesizer instrument. In some examples, at least one of the first electronic musical instrument or the second electronic musical instrument comprises an electronic keyboard instrument. In some examples, at least one of the first electronic musical instrument or the second electronic musical instrument comprises a theremin instrument. In some examples, at least one of the first electronic musical instrument or the second electronic musical instrument comprises a touchpad controller instrument. In some examples, at least one of the first electronic musical instrument or the second electronic musical instrument comprises sampler instrument.

At block 506, the method 500 can include implementing a controller mechanism in the guitar, wherein the controller mechanism is disposed in at least one of the neck portion and the body portion, and wherein controller mechanism is connected to at least one of the first electronic musical instrument and the second electronic musical instrument, and wherein the controller mechanism is configured to control at least one parameter of the first electronic musical instrument and the second electronic musical instrument. In some examples, the controller mechanism is configured to control one or more of the following parameters of the first electronic musical instrument: (i) volume; (ii) tone; (iii) pitch; (iv) modulation; (v) velocity control; (vi) oscillation; (vii) filter; (viii) release; (ix) attack; (x) sustain; and (xi) stored sound patches. In some examples, the controller mechanism is configured to control one or more of the following parameters of the second electronic musical instrument: (i) volume; (ii) tone; (iii) pitch; (iv) modulation; (v) velocity control; (vi) oscillation; (vii) filter; (viii) release; (ix) attack; (x) sustain; and (xi) stored sound patches. In some examples, the controller mechanism is configured to control an output parameter of at least one of the first electronic musical instrument and the second electronic musical instrument. In some examples, the controller mechanism is configured to control an output parameter of each of the first electronic musical instrument and the second electronic musical instrument, and wherein the controller mechanism is configured to blend between a first output of the first electronic musical instrument and a second output of the second electronic musical instrument, and wherein in a first position of the controller mechanism, the first output is greater than the second output, and wherein in a second position of the controller mechanism, the second output is greater than the first output. In some examples, the controller mechanism comprises a graphical user interface disposed on a top surface of the body portion.

In some additional or alternative embodiments, the musical device further comprises a battery to provide power to one or more of the first electronic musical instrument, the second electronic musical instrument, and the controller mechanism.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

We claim:

1. A musical device, wherein the musical device comprises:
a neck portion, wherein the neck portion comprises a first electronic musical instrument, and wherein the neck portion is configured to receive the first electronic musical instrument and conceal one or more portions of the first electronic musical instrument;
a body portion, wherein the body portion is connected to the neck portion, and wherein the body portion comprises a second electronic musical instrument, and wherein the body portion is configured to receive the second electronic musical instrument and conceal one or more portions of the second electronic musical instrument; and
a controller mechanism, wherein the controller mechanism is disposed in at least one of the neck portion and the body portion, and wherein the controller mechanism is connected to at least one of the first electronic musical instrument and the second electronic musical instrument, and wherein the controller mechanism is configured to control at least one parameter of the first electronic musical instrument and the second electronic musical instrument.

2. The musical device of claim 1, wherein at least one of the first electronic musical instrument or the second electronic musical instrument comprises a musical instrument digital interface (MIDI) instrument.

3. The musical device of claim 1, wherein at least one of the first electronic musical instrument or the second electronic musical instrument comprises a monophonic synthesizer instrument.

4. The musical device of claim 1, wherein at least one of the first electronic musical instrument or the second electronic musical instrument comprises a polyphonic synthesizer instrument.

5. The musical device of claim 1, wherein at least one of the first electronic musical instrument or the second electronic musical instrument comprises an electronic keyboard instrument.

6. The musical device of claim 1, wherein at least one of the first electronic musical instrument or the second electronic musical instrument comprises a theremin instrument.

7. The musical device of claim 1, wherein at least one of the first electronic musical instrument or the second electronic musical instrument comprises a touchpad controller instrument.

8. The musical device of claim 1, wherein at least one of the first electronic musical instrument or the second electronic musical instrument comprises a sampler instrument.

9. The musical device of claim 1, wherein the musical device is an acoustic guitar.

10. The musical device of claim 1, wherein the musical device is a solid-body electric guitar.

11. The musical device of claim 1, wherein the musical device is a semi-hollow-body electric guitar.

12. The musical device of claim 1, wherein the musical device is a hollow-body electric guitar.

13. The musical device of claim 1, wherein the musical device is a bass guitar.

14. The musical device of claim 1, wherein the controller mechanism is configured to control one or more of the following parameters of the first electronic musical instrument: (i) volume; (ii) tone; (iii) pitch; (iv) modulation; (v) velocity control; (vi) oscillation; (vii) filter; (viii) release; (ix) attack; (x) sustain; and (xi) stored sound patches.

15. The musical device of claim 1, wherein the controller mechanism is configured to control one or more of the following parameters of the second electronic musical instrument: (i) volume; (ii) tone; (iii) pitch; (iv) modulation; (v) velocity control; (vi) oscillation; (vii) filter; (viii) release; (ix) attack; (x) sustain; and (xi) stored sound patches.

16. The musical device of claim 1, wherein the controller mechanism is configured to control an output parameter of at least one of the first electronic musical instrument and the second electronic musical instrument.

17. The musical device of claim 16, wherein the controller mechanism is configured to control an output parameter of each of the first electronic musical instrument and the second electronic musical instrument, and wherein the controller mechanism is configured to blend between a first output of the first electronic musical instrument and a second output of the second electronic musical instrument, and wherein in a first position of the controller mechanism, the first output is greater than the second output, and wherein in a second position of the controller mechanism, the second output is greater than the first output.

18. The musical device of claim 1, wherein the controller mechanism comprises a graphical user interface disposed on a top surface of the body portion.

19. The musical device of claim 1, wherein the musical device further comprises a battery to provide power to one or more of the first electronic musical instrument, the second electronic musical instrument, and the controller mechanism.

20. A method for manufacturing a musical device, wherein the method comprises:
modifying a neck portion of a guitar to include a first electronic musical instrument, wherein the neck portion is modified to receive the first electronic musical instrument and conceal one or more portions of the first electronic musical instrument;
modifying a body portion of the guitar to include a second electronic musical instrument, wherein the body portion is modified to receive the second electronic musical instrument and conceal one or more portions of the second electronic musical instrument; and
implementing a controller mechanism in the guitar, wherein the controller mechanism is disposed in at least one of the neck portion and the body portion, and wherein controller mechanism is connected to at least one of the first electronic musical instrument and the second electronic musical instrument, and wherein the controller mechanism is configured to control at least one parameter of the first electronic musical instrument and the second electronic musical instrument.
